(19) United States
(12) Patent Application Publication
(10) Pub. No.: US 2008/0216565 A1
(43) Pub. Date: Sep. 11, 2008

(54) PROBE TIPS

(76) Inventors: Donato Ceres, Pasadena, CA (US); Yoshie Narui, Pasadena, CA (US); Charles Patrick Collier, San Marino, CA (US)

Correspondence Address: UNIDYM, 201 SOUTH LAKE AVE., SUITE 703, PASADENA, CA, 91101, US

(21) Appl. No.: 12/045,412

(22) Filed: Mar. 10, 2008

Related U.S. Application Data
(60) Provisional application No. 60/894,141, filed on Mar. 9, 2007.
(60) Provisional application No. 60/894,133, filed on Mar. 9, 2007.

(51) Int. Cl. G01B 5/28; G01D 21/00

(52) U.S. Cl. 73/105; 73/866.5

(57) ABSTRACT

Probe tips comprising tips and coatings are described. The tips and coatings may be selected to provide various probe-tip features, including, but not limited to, high reproducibility, high reliability, low cost, ultra-sharpness, high conductivity and/or simultaneous critical dimension imaging and sidewall roughness analysis.

This application claims priority to U.S. Provisional Patent Application No. 60/894,141, filed Mar. 9, 2007 and entitled “METHOD FOR FABRICATING CURVED CARBON NANOTUBES FOR CRITICAL DIMENSION IMAGING” and U.S. Provisional Patent Application No. 60/894,133, filed Mar. 9, 2007 and entitled “METHOD FOR FABRICATING ULTRA SHARP AND UNIFORM TIPS FOR PROXIMAL PROBE MICROSCOPES,” which are hereby incorporated herein by reference.

### BACKGROUND OF THE INVENTION

As semiconductor device features are continuously shrinking, technologies able to test new devices are requiring a great deal of miniaturization. Atomic force microscopy (AFM) is very useful for investigating small topographical features of the devices, but with a conductive probe it is possible to investigate also local electrical properties of the device. Metal-coated AFM tips are very useful for this purpose. In addition to probe new generation devices, conductive probes are also used for high-density data storage. The probe can be used as both a writing and a reading device. Currently the bit size is about 150 nm laterally, producing a surface density of about 29 Gbits per square inch. Ultra-sharp metallic tips can be of particular utility for memories based on conductance modification, however tip shape is extremely important for bit read/write and current coating techniques are not capable of providing sufficiently sharp or uniform tips able to produce features smaller than about 100 nm.

Emerging technologies, such as carbon nanotube-modified AFM tips, are very promising, but they still require a great deal of optimization and characterization. Additionally, methods for the fabrication of CNT conductive probe tips have not proven easily scalable to mass production, since each tip has to be individually modified and characterized.

### BRIEF SUMMARY OF THE INVENTION

In one embodiment, this invention describes a method for fabricating metal-coated AFM tips that can feature (1) very small apex radii and (2) extremely uniform coatings independent of the underlying tip shapes. Conductive probes presenting these two features can have numerous advantages compared to current probes.

In one embodiment, the invention described herein can provide a very reliable method for producing ultra-sharp conductive tips, regardless of the underlying silicon tip shape with radii on the order of 15 nm (FIGS. 1A, 1B, 2A and 2B). Although inexpensive silicon tips can be highly irreproducible especially at the tip apex, they do not constitute a problem for fabricating ultra-sharp metallic tips, but rather provide a very inexpensive substrate for high quality conductive tips. Additionally, because the metallic coating fabricated using the disclosed method can be highly uniform, all tips, regardless of their initial shape, can be essentially identical (FIGS. 1A and 1B). This minimizes considerably the probability of fabrication failures. Both these features of the invention described herein can enable the fabrication of highly reproducible, reliable, and inexpensive ultra-sharp, conductive AFM probes.

The tips manufactured using certain embodiments can be used in applications such as electrical measurements of conductive surfaces, surface modification with biological molecules, micro-or nanoelectrodes for electrochemical applications, and dip-pen lithography, just to name a few.

In one embodiment, a CNT probe may comprise (1) a long CNT with a high aspect ratio, (2) CNT tilted to a tunable angle for sidewall imaging, (3) silicon dioxide coating that provides mechanical stability, and (4) the silicon dioxide thickness is tunable for improved resolution. This embodiment can provide CNT tips for both critical dimension imaging and sidewall roughness analysis.

In one embodiment, fabrication of a probe that enables both critical dimension imaging and sidewall roughness measurement may comprise a curved CNT covered with silicon dioxide (e.g., formed via gas-phase reactions of TEOS in an inductively-coupled plasma reactor as described in U.S. Pat. No. 10/783,713, which is hereby incorporated herein by reference). The CNT is preferably at an angle with respect to the axis of symmetry of the tip. Because of its length and high aspect ratio, this probe enables critical dimension imaging, while the tilt enables simultaneous sidewall roughness measurement.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed.

### BRIEF DESCRIPTION OF THE FIGURES

FIGS. 1A and 1B: Two scanning electron micrographs of two different tips, covered with 20 nm chromium layer in a sputter coater. Both tips are essentially identical after deposition, although the underlying silicon apex differs from one another.

FIGS. 2A and 2B: A scanning transmission micrograph of two silicon tip covered with 20 nm chromium layer. The inner grayer area represents the silicon tip. It is possible to see how the underlying silicon tip surface does not affect the metallic tip shape.

FIG. 3: Scanning electron micrographs of a 950 nm long CNT covered with 20 nm (nominal thickness) of silicon dioxide. The CNT is bent at a 35° angle with respect to the tip axis. The critical width for this particular tip is only 380 nm.

### DESCRIPTION OF THE INVENTION

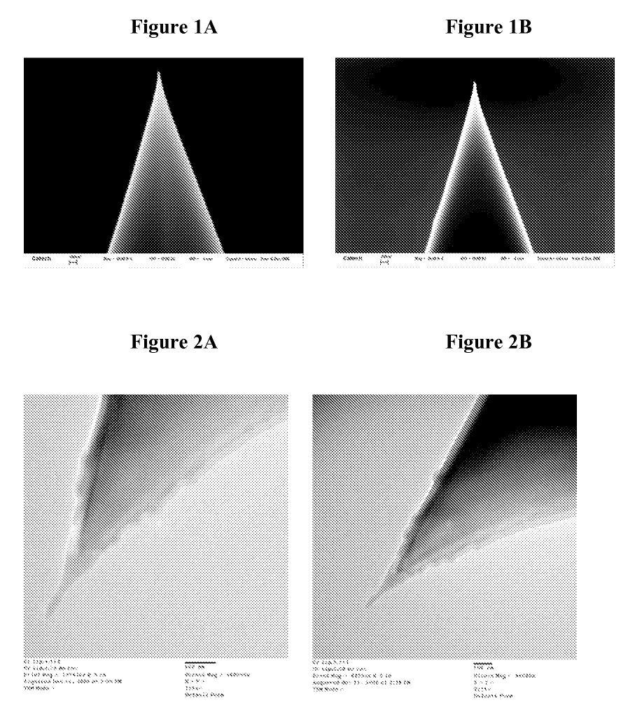

The method described herein can allow the manufacture of ultra-sharp conductive AFM tips, regardless of the quality of the underling tip shape. Typically this is achieved by using a regular silicon tip, although the tip material is not a specific requirement for the invention. In alternative embodiments, the tip can be made of silicon nitrate. In preferred embodiments of the present invention, an AFM tip is placed in a sputter coater equipped with a planetary rotating stage. In alternative embodiments, metal evaporation based on resistive heating or an electron beam can be used for the purpose of the invention. Referring to FIGS. 1 and 2, a planetary rotating stage will allow the tip to be coated uniformly and enable the metal coating to grow regularly around the tip apex to form the ultra sharp metallic tip.

The deposited metal can be of different nature. Referring to FIGS. 2A and 2B, a single layer of 10 to 20 nm thickness of a metal, such as chromium can be used to produce ultra sharp chromium tips. Alternatively, multilayered metallic coating can also be used. For instance, an adhesion layer of chromium followed by gold, or platinum-iridium, or any combination of these two or other metals are also possible. The thickness of the metallic layer depends on the apex radius desired, which in turn depends on the specific characteristics of the deposited metal. For instance, chromium and platinum generally tends to form smoother surfaces, while gold forms larger grains. The appropriate combination of metal type, deposition rate, and thickness enables the fine tuning of the final apex radii.

A method described herein can allow the manufacture of curved CNTs for critical dimension imaging and sidewall roughness analysis. In a preferred embodiment of the present invention, this is achieved by first coating the CNT-modified AFM tip with a thick coating of silicon dioxide in the inductively-coupled plasma reactor. The thickness of the coating can vary by accurately controlling the influx of the silicon precursor. Subsequently, the tip can be placed in a scanning electron microscope. If the CNT is poorly electrically connected to the tip, electron bombardment causes charging of the CNT. It has been shown that CNTs can be bent electrostatically (Science, 1999, 283, 1513) and in particular, using a transmission electron microscope (Appl. Phys. Lett., 1998, 73, 1961), by the same principle. On a bare CNT, the bending is essentially reversible and the CNT is restored to its original shape when it is no longer subjected to the electrostatic perturbation.

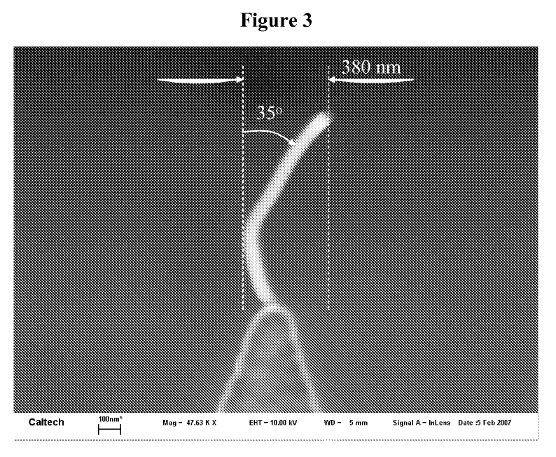

Referring to FIG. 3, the tip can be very long and access the bottom of deep trenches. The slight tilt angle, for example 35°, can allow the easy imaging of sidewalls of trenches without the need to change the probe. Strengthening the attachment site of a CNT to the AFM tip substrate is a critical technological challenge, and an important feature of this new probe is the silicon dioxide coating that can provide greater stability to the attached CNT. Moreover, the thickness can be adjusted inside the plasma chamber by modifying the precursor flow rate. A thinner coating provides a smaller tip apex radius and thus better spatial resolution.

In a further embodiment of the present invention, silicon dioxide can provide an inelastically deformable coating that keeps the CNT in place after the bending. Preferably, stiffness is provided by this coating of silicon dioxide, which is non-conductive, and bending is obtained from an in-flux of electrons that charge the coated-CNT. Moreover, depending on the location of the focused electron beam, the CNT can be kinked relatively sharply at any location (FIG. 3).

The present invention has been described above with reference to preferred features and embodiments. Those skilled in the art will recognize, however, that changes and modifications may be made in these preferred embodiments without departing from the scope of the present invention.

What is claimed is:

1. A probe tip, comprising:
a tip; and
a coating, wherein the coating is coated over the tip, and
wherein the coating is highly uniform.

2. The probe tip of claim 1, wherein the coating is a metal coating.

3. The probe tip of claim 2, wherein the coating has a thickness of 10 to 20 nm.

4. The probe tip of claim 3, wherein the metal coating comprises a layer of chromium.

5. The probe tip of claim 4, wherein the metal coating further comprises at least one other metal layer.

6. The probe tip of claim 5, wherein the tip comprises at least one of silicon and silicon nitrate.

7. The probe tip of claim 6, wherein the other metal layer comprises at least one of gold and platinum-iridium.

8. The probe tip of claim 1, wherein the tip comprises a carbon nanotube and the coating comprises silicon dioxide.

9. The probe tip of claim 8, wherein the CNT is curved.

10. The probe tip of claim 9, wherein the CNT is positioned at a tilt angle provides such that it provides both critical dimension imaging and sidewall roughness data.

11. A method of producing the probe tip of claim 1, wherein the coating is applied to the tip by at least one of sputter coating, metal evaporation and an inductively-coupled plasma reactor.

12. The method of claim 11, wherein the coating is a metal coating,
wherein the coating is applied to the tip by sputter coating, and
wherein the tip is coated in a planetary rotating stage.

13. The method of claim 11, wherein the coating is silicon dioxide,
wherein the tip comprises a CNT, and
wherein the tip is coated in an inductively-coupled plasma reactor.
